(19) United States
(12) Patent Application Publication
(10) Pub. No.: US 2008/0311022 A1
(43) Pub. Date: Dec. 18, 2008

(54) METHODS AND APPARATUSES FOR AMMONIA PRODUCTION

(75) Inventors: Robert A. Carrington, Idaho Falls, ID (US); Richard D. Boardman, Idaho Falls, ID (US); Richard A. Wood, Idaho Falls, ID (US); Jason C. Stolworthy, Idaho Falls, ID (US)

Correspondence Address: BATTELLE ENERGY ALLIANCE, LLC, P.O. BOX 1625, IDAHO FALLS, ID, 83415-3899, US

(73) Assignee: Battelle Energy Alliance, LLC, Idaho Falls, ID (US)

(21) Appl. No.: 11/763,323

(22) Filed: Jun. 14, 2007

(51) Int. Cl. C01C 1/02

(52) U.S. Cl. 423/359; 204/242

(57) ABSTRACT

Processes for the production of ammonia may include the production of nitrogen from the combustion of a stream or slipstream of hydrogen mixed with air. Hydrogen used to produce the nitrogen for an ammonia combustion process may be generated from the electrolysis of water. Hydrogen produced by the electrolysis of water may also be combined with nitrogen to produce ammonia. Apparatuses for the production of ammonia and constituents used to produce ammonia are also disclosed.

### GOVERNMENT RIGHTS

The United States Government has certain rights in this invention pursuant to Contract No. DE-AC07-05-ID14517, between the United States Department of Energy and Battelle Energy Alliance, LLC.

### FIELD OF THE INVENTION

Embodiments of the invention relate generally to methods for producing ammonia from hydrogen and nitrogen and, more particularly, to the production of ammonia from hydrogen and from nitrogen produced by the combustion of hydrogen with air.

### BACKGROUND

Ammonia (NH₃) is one of the most highly-produced inorganic chemicals in the world, in part, because ammonia is used in many different processes and as a chemical agent for many different applications. For example, ammonia is used in fertilizers, explosives, and as a reactant for reducing pollutants, especially NOₓ pollutants.

Many different processes and methods have been developed to produce ammonia. Typically, conventional ammonia production processes convert natural gas, liquid petroleum gas, or petroleum naphtha into gaseous hydrogen. Nitrogen is conventionally produced using an air splitting apparatus. The gaseous hydrogen is then reacted with the nitrogen in the presence of a catalyst to produce ammonia. For example, hydrogen and nitrogen are reacted in a 3 to 1 ratio in a Haber process according to Reaction 1 to produce ammonia:

3 H₂+N₂→2 NH₃ (1).

The conversion of carbon-containing compounds, such as natural gas, liquefied petroleum gas, coal, and petroleum naphtha, into hydrogen requires significant processing to separate hydrogen from the other components found in the carbon-containing compounds. For instance, conventional processes based on natural gas reforming first remove sulfur pollutants from the carbon-containing compounds and then steam-reform the sulfur-free carbon-containing compounds to form hydrogen and carbon monoxide. A catalytic shift conversion is then used to convert the carbon monoxide to carbon dioxide and additional hydrogen. Carbon dioxide is removed from the hydrogen such as by using pressure swing absorbers (PSA), membranes, or acid gas scrubbing processes. Catalytic methanation of the product removes any residual carbon monoxide or carbon dioxide from the hydrogen product. The resulting hydrogen may be reacted with purified nitrogen according to Reaction 1 to produce ammonia.

The production of ammonia is conventionally performed on a large scale and fluctuations in the costs associated with feed gases, such as carbon-containing gases, result in fluctuations in the price of ammonia in different parts of the world. With rising costs of natural gas and petroleum products in the United States, much of the United States' consumption of ammonia is satisfied from ammonia production plants overseas. In order to meet the demands of ammonia consumption, alternative processes for producing ammonia must be explored. One such process relies upon the production of hydrogen from coal stocks, which are plentiful in the United States. However, the conversion of coal to hydrogen also produces significant amounts of unwanted pollutants. Processes for reducing such pollutants are expensive, and as tighter emissions standards and requirements are implemented, the expenses associated with pollutant control in coal to hydrogen processes will increase.

Therefore, it is desirable to develop new methods for producing ammonia. It is also desirable to develop methods for producing ammonia which are cheaper than existing methods and processes which do not generate the amount of pollutants associated with conventional ammonia producing processes. In addition, it is desirable to develop methods for producing ammonia near the point of use, reducing costs associated with transporting and storing the ammonia.

### SUMMARY OF THE INVENTION

According to embodiments of the invention, ammonia may be produced from nitrogen and hydrogen. Nitrogen for the production of ammonia may be produced by combusting hydrogen with air. Air, including oxygen, may be combined with an excess of hydrogen, or in a fuel rich environment, in a combustion process to ensure that all of the oxygen in the air is combusted or converted to water vapor. The resulting moist nitrogen product may be dried and used in the production of ammonia.

According to various embodiments of the invention, a hydrogen stream or a hydrogen slipstream may be combusted in air to produce nitrogen for use with an ammonia production process. The combustion of the hydrogen with air may produce a moist nitrogen product including nitrogen and water vapor. In some embodiments, combustion of the hydrogen with air occurs in a fuel rich environment, wherein the products produced by the combustion include water vapor and nitrogen, or moist nitrogen. The moist nitrogen may be dried to remove the water vapor from the nitrogen, providing a dry nitrogen product that may be used in the formation of ammonia.

According to other embodiments of the invention, hydrogen produced by the decomposition of water into hydrogen and oxygen may be used to produce ammonia. In some embodiments, hydrogen may be produced from water using an electrolysis process. However, the hydrogen may be produced by coal gasification, methane reforming, or other processes. The electrolysis process may be powered by one or more energy power sources or clean energy power sources, such as coal, nuclear, or gas fired power generation, or one or more renewable energy power sources, such as solar power, wind power, hydroelectric power, geothermal power, or nuclear power. The hydrogen produced by the decomposition of water may be combined with nitrogen to produce ammonia according to conventional methods.

In still other embodiments of the invention, hydrogen produced by the decomposition of water may be combined with air and combusted to produce a moist nitrogen product including nitrogen and water vapor. The moist nitrogen product may be dried to remove at least some of the water vapor from the nitrogen. The resulting dry nitrogen may be combined with hydrogen produced by the decomposition of water to produce ammonia. In some embodiments, the combination of nitrogen and hydrogen may include the combination of one part nitrogen to three parts hydrogen.

According to various embodiments of the invention, the combustion of hydrogen and air to produce nitrogen may also be used to drive a turbine that produces electricity. In other embodiments, the combustion of hydrogen and air produces heat that may be recovered, such as by using a heat exchanger.

Embodiments of apparatuses configured for the production of ammonia according to various embodiments of the invention, and for production of constituents used for ammonia production, are also encompassed by the present invention.

### BRIEF DESCRIPTION OF THE DRAWINGS

While the specification concludes with claims particularly pointing out and distinctly claiming that which is regarded as the present invention, this invention can be more readily understood and appreciated by one of ordinary skill in the art from the following description of the invention when read in conjunction with the accompanying drawings in which:

FIGS. 1 and 2 illustrate processes for producing ammonia according to particular embodiments of the invention;

FIG. 3 illustrates another process feed scheme for introducing hydrogen and air to a combustion process according to various embodiments of the invention;

FIGS. 4A-4C illustrate various embodiments of combustion apparatuses that may be used with processes for producing ammonia according to embodiments of the invention;

FIG. 5 illustrates a process for producing hydrogen according to embodiments of the invention; and

FIGS. 6-9 illustrate a process for producing ammonia according to particular embodiments of the invention.

### DETAILED DESCRIPTION OF THE ILLUSTRATED EMBODIMENT

According to some embodiments of the invention, nitrogen may be produced by the combustion of hydrogen using air. Air includes about 21% by volume of oxygen, about 78% by volume of nitrogen, and other gaseous components, such as argon and carbon dioxide (about 1.0% by volume). The hydrogen may be provided as a hydrogen stream or a hydrogen slipstream, which are collectively referred to herein as a hydrogen stream. The combustion of the hydrogen with air may be performed in a fuel rich environment, for example in the presence of excess hydrogen, to facilitate the production of a moist nitrogen product including nitrogen and water vapor.

According to embodiments of the invention, a process for the production of ammonia may include the formation of a moist nitrogen stream through the combustion of a hydrogen slipstream or a hydrogen stream with air. The moist nitrogen stream may be dried to remove the water in the nitrogen stream and the nitrogen may be combined with additional hydrogen in sufficient ratios to produce ammonia. In some embodiments, at least a portion of the hydrogen may include hydrogen originating from, or generated from, a non-carbon containing compound, such as water. In still other embodiments, at least a portion of the hydrogen that is combined with the nitrogen to produce ammonia may originate from, or be generated from, a carbon-containing compound.

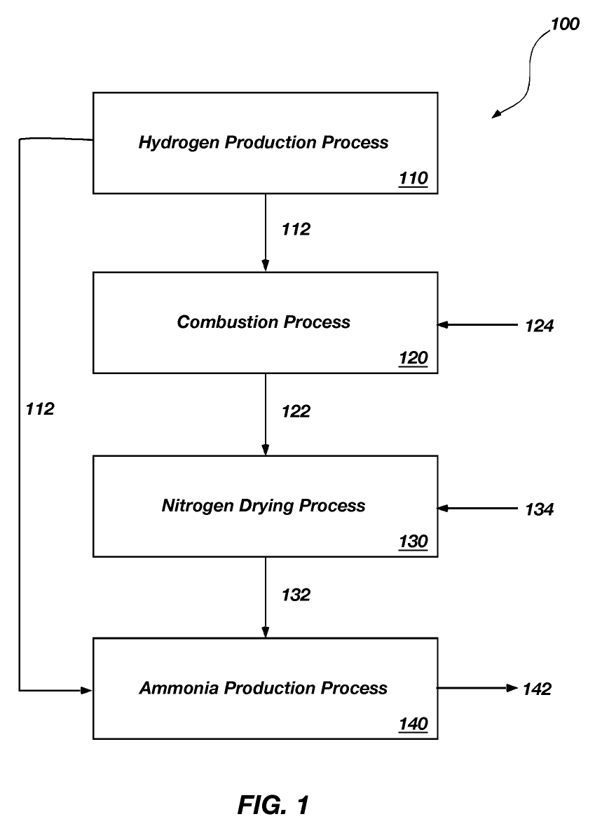

A process 100 for producing ammonia according to particular embodiments of the invention is illustrated in FIG. 1. The process 100 may include a hydrogen production process 110, a combustion process 120 configured to combust hydrogen 112 produced by the hydrogen production process 110 with air 124 to produce moist nitrogen 122, a drying process 130, and an ammonia production process 140.

Hydrogen 112 produced in the hydrogen production process 110 may be produced by conventional methods wherein carbon-containing gases or liquids, such as, but not limited to, liquid and gaseous petroleum products, are reacted to produce hydrogen 112. For example, hydrogen 112 may be produced from liquid petroleum products, gaseous petroleum products, coal, coal wastes, oil shale, biomass, refuse derived wastes, or other carbon-containing compounds. In other embodiments of the invention, hydrogen 112 produced in the hydrogen production process 110 may be produced from non-carbon-containing compounds, such as water. For instance, hydrogen 112 may be produced from the electrolytic or thermochemical conversion of water into hydrogen 112 and oxygen. Alternatively, the hydrogen 112 may be produced by coal gasification, methane reforming, or other conventional process.

At least a portion of the hydrogen 112 produced in the hydrogen production process 110 may be fed to a combustion process 120. The hydrogen 112 may be combined with, or combusted in the presence of air 124 fed to the combustion process 120. The combustion of hydrogen 112 with the air 124 in the combustion process 120 produces a moist nitrogen 122 product. In this embodiment, the production of the moist nitrogen 122 product may eliminate the need for air separation apparatuses in the ammonia production process 140. As such, the need for additional, expensive equipment in the production of ammonia may be eliminated. However, to improve the efficiency of the ammonia production process 140, air separation apparatuses may, optionally, be used, as described below.

In some embodiments, the combustion of the hydrogen 112 and air 124 may occur in a fuel rich environment which may facilitate the production of the moist nitrogen 122 product from the combustion process 120. For example, excess hydrogen 112 may be fed to the combustion process 120 to ensure the combustion of all of the oxygen in the air 124.

The moist nitrogen 122 may be fed to a drying process 130 to dry the moist nitrogen 122 and produce a nitrogen 132 product that may be used to produce ammonia. Water 134 removed from the moist nitrogen 122 in the drying process 130 may be recovered for other uses, such as for the production of additional hydrogen 112 in a hydrogen production process 110.

Nitrogen 132 from the drying process 130 may be combined with hydrogen 112 from the hydrogen production process 110 in the ammonia production process 140 to produce ammonia. For instance, nitrogen 132 may be combined with hydrogen 112 in a 1 to 3 (N to H) ratio, respectively, to produce ammonia 142 using conventional processes in the ammonia production process 140. Unreacted hydrogen 112 and nitrogen 132 may be recovered and returned to the ammonia production process 140 to produce additional ammonia 142.

According to other embodiments of the invention, hydrogen produced or generated from one or more non-carbon-containing compounds may be fed as a hydrogen slipstream or a hydrogen stream to a combustion process with air to produce moist nitrogen. The moist nitrogen may be at least partially dried and combined with hydrogen produced or generated from one or more non-carbon-containing compounds to produce ammonia.

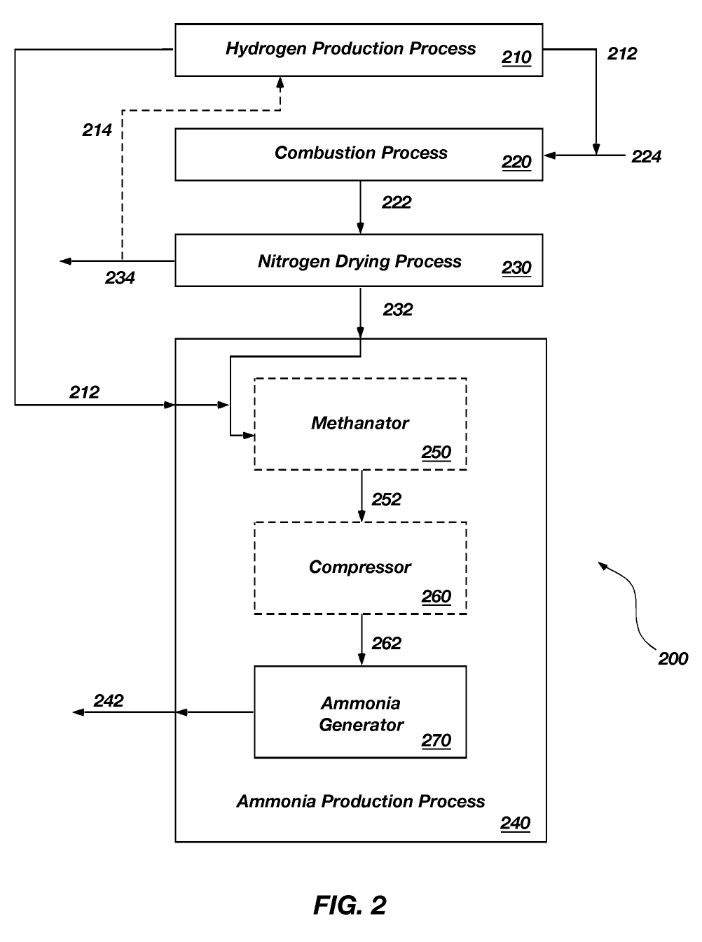

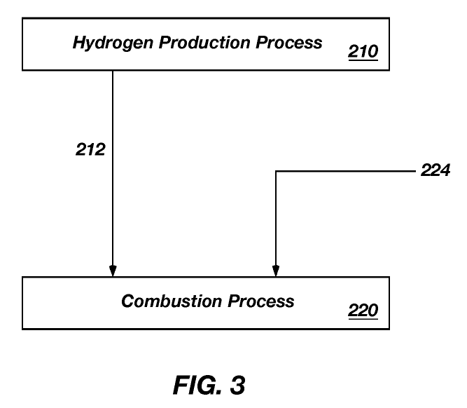

For example, a process 200 for producing ammonia 242 according to particular embodiments of the invention is illustrated in FIG. 2. A hydrogen production process 210 may be used to generate or produce hydrogen 212 from one or more non-carbon-containing compounds. At least a portion of the hydrogen 212 produced in the hydrogen production process 210 may be fed to a combustion process 220. In some embodiments of the invention, hydrogen 212 may be combined with an air stream 224 being fed to the combustion process 220 as illustrated in FIG. 2. In other embodiments of the invention, hydrogen 212 and air 224 may be fed to the combustion process 220 separately and combined for combustion within the combustion process 220 as illustrated in FIG. 3. Combustion of the air 224 and hydrogen 212 fed to the combustion process 220 may produce a moist nitrogen 222 product that may be fed to a drying process 230 to dry the moist nitrogen 222 and produce nitrogen 232. The moist nitrogen 222 product includes nitrogen, water, and hydrogen. Water 234 from the drying process 230 may be recovered and used elsewhere in the process 200. Nitrogen 232 from the drying process 230 may be fed to an ammonia production process 240 where nitrogen 232 and hydrogen 212 are combined to produce ammonia 242.

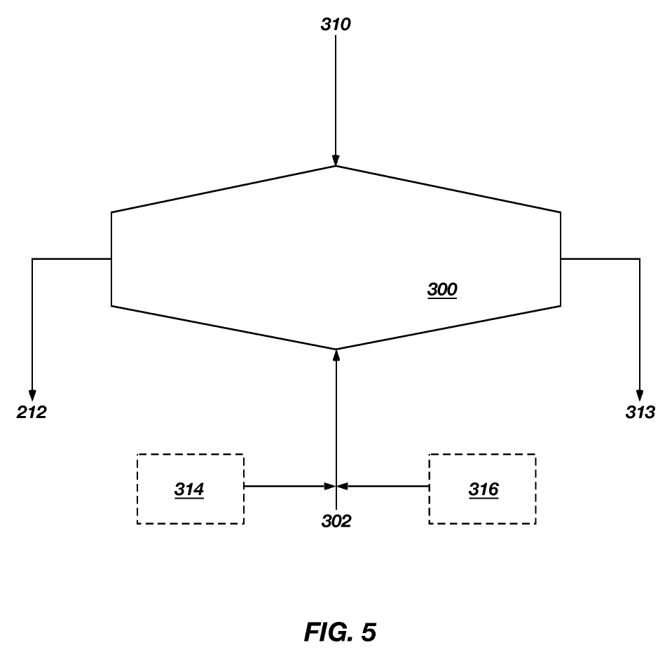

According to certain embodiments of the invention, the hydrogen production process 210 may include one or more processes configured to produce hydrogen 212 from water, such as by the electrolysis of water. For example, water 310 may be fed to one or more electrolytic cells 300, as illustrated in FIG. 5, where electricity 302 supplied to the electrolytic cell 300 decomposes the water 310 into hydrogen 212 and oxygen 313 according to Reaction 2:

2H₂O→2H₂+O₂ (2).

The hydrogen 212 produced by the electrolytic cell 300 is free of carbon-containing compounds which are commonly present in hydrogen produced by conventional processes that produce hydrogen from hydrocarbon-based products.

Electricity 302 for operating one or more electrolytic cells 300 in a hydrogen production process 210 may be produced or obtained from numerous sources, including conventional electricity sources 314 such as coal-fired or gas-fired power plants or other combustion-based power plants. In some embodiments, electricity 302 may be generated or obtained from clean or renewable energy sources 316, such as solar power, geothermal power, hydroelectric power, wind power, or nuclear power. The use of clean or renewable energy sources 316 to produce the electricity 302 used to generate hydrogen 212 in the hydrogen production process 210 reduces the overall amount of pollutants generated by process 200 as compared to conventional ammonia production processes. In addition, the use of clean or renewable energy sources 316 to supply electricity to the hydrogen production process 210 allows the hydrogen production process 210 to be transported or moved. For example, a hydrogen production process 210 that may be operated using solar power may be transported to and from the various locations where ammonia 242 production is desired. The availability of solar energy in remote locations allows the hydrogen production process 210 to be operated in locations that would otherwise be unable to support a conventional ammonia production process.

In other embodiments, hydrogen 212 may be generated from water using a high temperature electrolysis process, or HTE process. High temperature electrolysis processes convert water into hydrogen and oxygen through thermolysis, or the application of heat. When heat and electrical current are applied to a high temperature electrolysis cell, water, in the form of steam, may be converted or decomposed into hydrogen and pure oxygen. Nuclear power and nuclear power plants may be configured to provide the necessary heat and electricity to power a hydrogen production process 210 utilizing high temperature electrolysis processes. The use of nuclear power plants to provide the necessary heat and electricity may reduce the amount of pollutants associated with the production of ammonia 242 by process 200. Conventional electrolysis processes may also be used with various embodiments of the invention to produce hydrogen 212.

The combustion processes 220 may combust hydrogen 212 fed to the combustion process 220 with air 224. The amount of hydrogen 212 fed to the combustion process 220 may be controlled or configured to ensure complete combustion of the oxygen in the air 224 fed to the combustion process 220. In some embodiments, excess hydrogen 212 may be fed to the combustion process 220 to ensure that the only products from the combustion process 220 are water vapor and nitrogen. The amount of air 224 being fed to the combustion process 220 may also be controlled or configured to ensure that all of the oxygen in the air 224 is consumed.

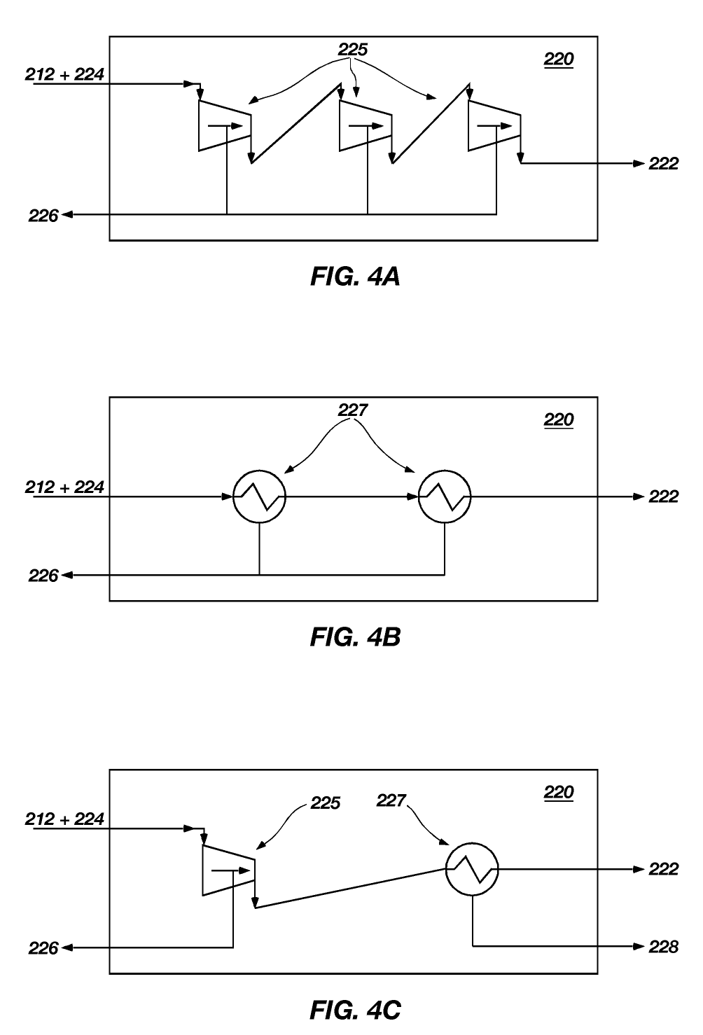

Combustion processes 220 that may be incorporated with various embodiments of the invention may include any number of combustion processes or combustion apparatuses configured to produce moist nitrogen 222 from the combustion of air 224 and hydrogen 212. For example, combustion process 220 may include one or more combustion turbines 225 as illustrated in FIG. 4A. The hydrogen 212 and air 224 fed to the combustion process 220 may be combusted in one or more combustion turbines 225, such as turbogenerators, to produce a moist nitrogen 222 product. The combustion of the hydrogen 212 and air 224 within the one or more combustion turbines 225 may be used to produce electricity 226 that may be used in process 200 or used in other processes. A combustion process 220 may also produce heat 228 as illustrated in FIGS. 4B and 4C. The hydrogen 212 and air 224 fed to the combustion process 220 may be combusted and the heat 228 produced by the combustion of the hydrogen 212 and air 224 may be captured by one or more heat exchangers 227 as illustrated in FIG. 4B. The heat 228 captured by the combustion process 220 may be used elsewhere in process 200 or in other processes. Further, as illustrated in FIG. 4C, the combustion process 220 may include one or more combustion turbines 225 and one or more heat exchangers 227. A combustion process 220 such as that illustrated in FIG. 4C may produce both electricity 226 and heat 228 which may be used in the process 200 or in other processes.

According to other embodiments of the invention, the combustion process 220 may also be configured to dry the moist nitrogen 222. In such instances, the drying process 230 may be eliminated from process 200 and a nitrogen 232 product may be produced by the combustion process 220.

Drying process 230 incorporated with embodiments of the invention may include any conventional drying process configured to remove water or moisture from a gas. In particular, a drying process 230 incorporated with process 200 may be configured to remove water or water vapor from a moist nitrogen 222 gas stream. Water 234 or water vapor removed from the moist nitrogen 222 gas may be recovered and used in the process 200, discarded as waste, or used in other processes. For example, at least a portion of the water 234 recovered from the moist nitrogen 222 in the drying process 230 may be recycled to the hydrogen production process 210 and used as feed water 214 for the generation of hydrogen 212 as illustrated by the optional feed water 214 stream illustrated using dashed lines in FIG. 2.

An ammonia production process 240, according to various embodiments of the invention, may include one or more conventional ammonia production processes configured to produce ammonia 242 from nitrogen 232 and hydrogen 212. Nitrogen 232 and hydrogen 212 may be fed to the ammonia production process 240 in a desired ratio, and preferably in a ratio of about 3 to 1, respectively. The combination of nitrogen 232 and hydrogen 212 within the ammonia production process 240 may produce ammonia 242. Unreacted hydrogen 212 and nitrogen 232 may be recovered and returned to the ammonia production process 240 to produce additional ammonia.

According to some embodiments of the invention, the ammonia production process 240 may include one or more methanators 250, one or more compressors 260, and one or more ammonia generators 270. Optional methanator 250 and compressor 260 are illustrated using dashed lines in FIG. 2. Nitrogen 232 and hydrogen 212 fed to the ammonia production process 240 may be circulated through one or more methanators 250 to remove any residual carbon-containing compounds, such as carbon monoxide (CO) and carbon dioxide (CO₂), which are introduced into the ammonia production process 240 with the air 224. The nitrogen 232 and hydrogen 212 mixture 252 from a methanator 250 may be compressed in one or more compressors 260. The compressed mixture 262 may be fed to one or more ammonia generators 270 configured to produce ammonia 242 from the compressed mixture 262 of nitrogen 232 and hydrogen 212. An ammonia generator 270 may include any conventional process or apparatus configured for converting a stream of nitrogen 232 and hydrogen 212 into ammonia 242. For example, an ammonia generator 270 may produce ammonia 242 from hydrogen 212 and nitrogen 232 according to the Haber process.

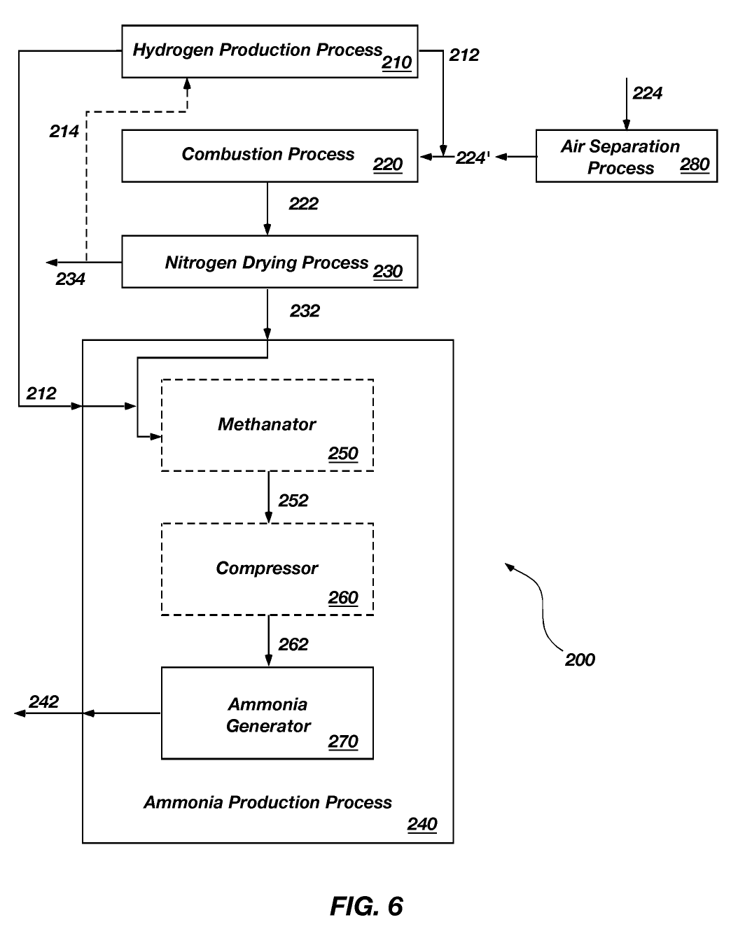

To improve the efficiency of the ammonia production process 240, the air 224 may be passed or flowed through an air separation process 280, producing air 224′, as shown in FIG. 6. Air 224′ may be enriched in nitrogen compared to air 224 and is also referred to herein as nitrogen enriched air. The air separation process 280 may be used to remove at least a portion of the oxygen and other gaseous components from the air 224. The air separation process 280 may be used to produce air 224′ having from about 95% by volume to about 99% by volume of nitrogen, from about 1% by volume to about 5% by volume of oxygen, and carbon dioxide at less than about 0.035% by volume. The air separation process 280 may be operatively coupled to combustion process 120, 220. Air 224′ and hydrogen 212 may be combined and combusted in the combustion process 220.

The air separation process 280 may include a membrane or a PSA for producing the nitrogen enriched air. Such membranes and PSAs are known in the art and, therefore, are not discussed in detail herein. By way of non-limiting example, the membrane may be made from a polymeric material or a metal material, such as a palladium/gold membrane. Such membranes are commercially available from numerous sources including, but not limited to, Praxair Technology, Inc. (Danbury, Conn.), Universal Industrial Gases, Inc. (Easton, Pa.), Air Liquide (Paris, France), or Air Products and Chemicals, Inc. (Lehigh Valley, Pa.). The PSA may be an activated alumina, a zeolite, such as a molecular sieve zeolite, or an activated carbon molecular sieve. The PSA may include, but is not limited to, a calcium-exchanged type X zeolite, a strontium-exchanged type X zeolite, or a calcium-exchanged type A zeolite. PSAs are commercially available from numerous sources including, but not limited to, Questair Technologies Inc. (Burnaby, Canada), SeQual Technologies Inc. (San Diego, Calif.), Sepcor, Inc. (Houston, Tex.), and Praxair Technology, Inc. (Danbury, Conn.).

After removing at least a portion of the oxygen and carbon dioxide, air 224′ may be introduced into the combustion process 220. When combusted, the hydrogen 212 and the air 224′ may produce the moist nitrogen 222 product, which includes nitrogen, water, and hydrogen 212. As previously described, the moist nitrogen 222 product is dried in the nitrogen drying process 230, producing nitrogen 232. The hydrogen 212 and the nitrogen 232 are reacted in the ammonia production process 240 to form ammonia. Since the air separation process 280 removes oxygen and carbon dioxide, the methanator 250 and compressor 260 may be optional in ammonia production process 240, as illustrated in FIG. 6 using dashed lines. However, if the methanator 250 is present, the methanator 250 may be smaller in size than a methanator 250 used to remove the residual carbon-containing compounds where the air 224 is combusted with hydrogen, as described above in regard to FIG. 2.

Combusting the hydrogen 212 and the air 224′ may provide several advantages. Since air 224′ (nitrogen enriched air) includes a higher purity of nitrogen, less energy is used to combust the hydrogen 212 with air 224′ during the combustion process 220, improving its efficiency. For comparison, from about 1% by volume to about 5% by volume of hydrogen 212 is combusted with air 224′ (nitrogen enriched air) in combustion process 220, while about 20% by volume of hydrogen 212 is combusted with air 224 in combustion process 220. In addition, a smaller generator for producing hydrogen 212 in the hydrogen production process 210 may be used. The energy used to separate the nitrogen to a purity of between about 95% by volume and about 99% by volume may also be less than that used to purify the nitrogen to 99.9% purity. In addition, if the air separation process 280 includes a membrane, separating the nitrogen to the former purity level utilizes fewer membranes than separating the nitrogen to 99.9% purity. Furthermore, since water is produced by the combustion of hydrogen 212 and 224′ and less combustion is needed for the reasons described above, less drying of the moist nitrogen 222 product in the nitrogen drying process 230 may be needed. The reduced energy consumption in the combustion process 220, combined with the use of fewer membranes if the air separation process 280 includes a membrane, results in substantial cost savings.

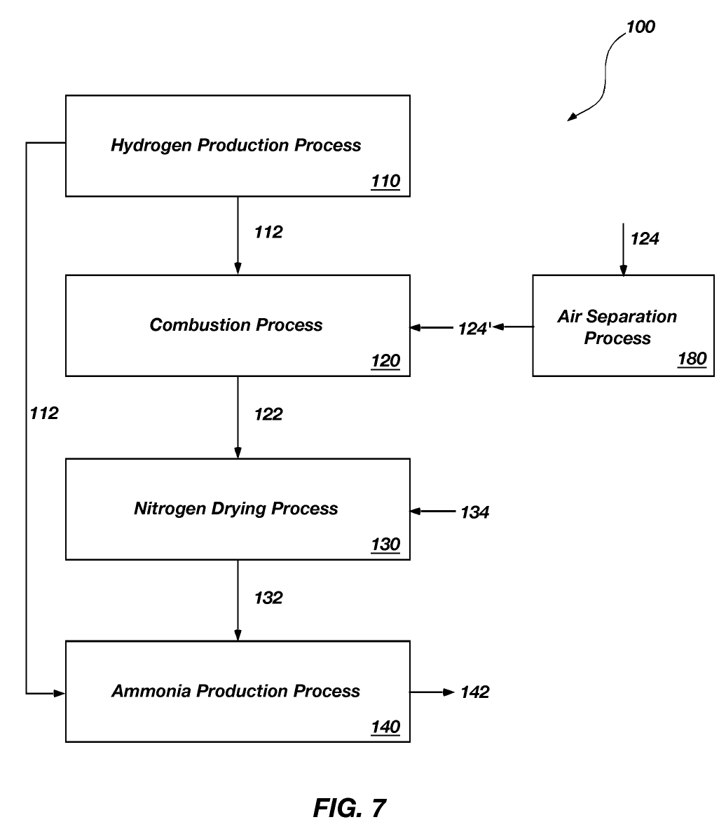

As illustrated in FIG. 7, an air separation process 180 may also be used with the ammonia production process 140 without using a methanator 250 and compressor 260. The air separation process 180 may be substantially as described above.

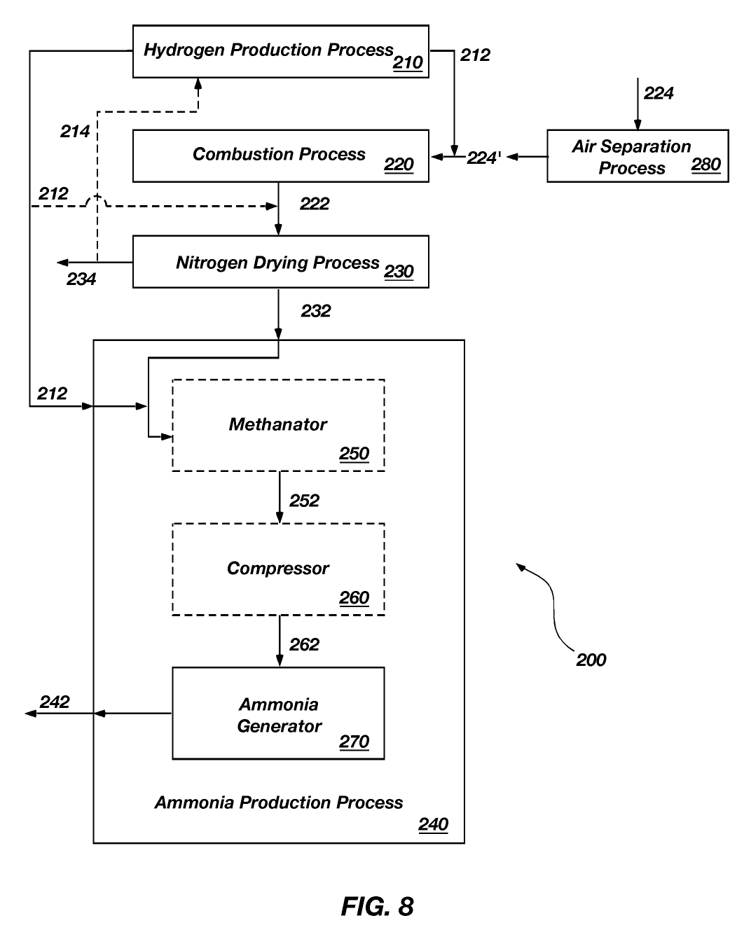

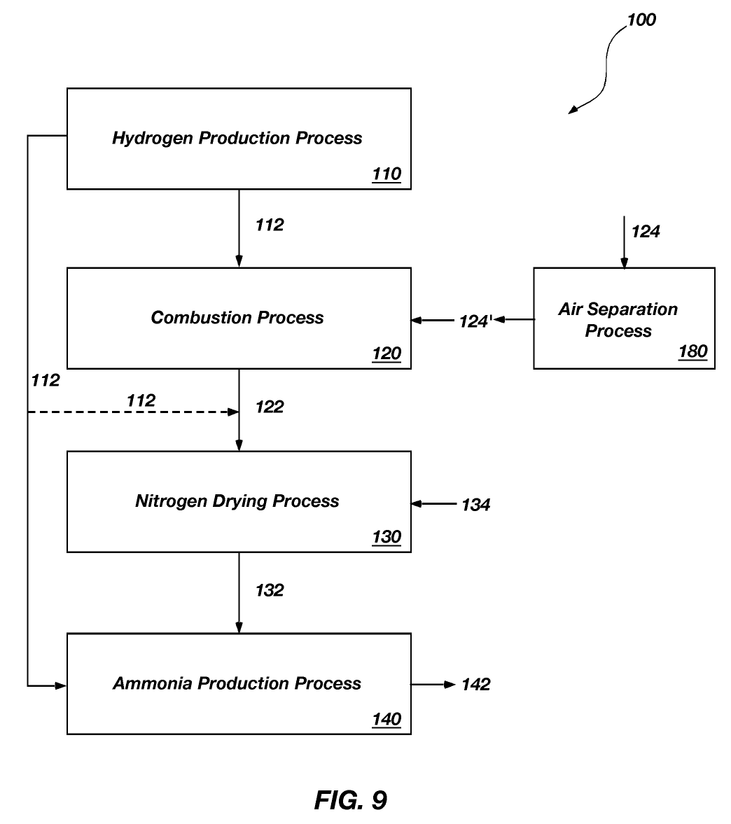

To achieve optimal combustion, a portion of the hydrogen 212 produced by hydrogen production process 210 may, optionally, be diverted from the combustion process 220. The optional hydrogen 212 slipstream is illustrated using a dashed line in FIG. 8. The optional hydrogen 212 slipstream may be combined with moist nitrogen 222 product before drying in the nitrogen drying process 230. Similarly, a portion of the hydrogen 112 produced by hydrogen production process 110 may, optionally, be diverted from the combustion process 120. The optional hydrogen 112 slipstream is illustrated using a dashed line in FIG. 9. The optional hydrogen 212 slipstream may be combined with moist nitrogen 122 product before drying in the nitrogen drying process 130.

The ammonia production processes of various embodiments of the invention may be used to produce ammonia for a number of different processes and applications. The scalability of the ammonia production processes of embodiments of the invention may also be beneficial because ammonia production may be scaled to a desired size to produce sufficient amounts of ammonia for a particular process on site.

For example, in certain embodiments of the invention the small scale of the hydrogen production process 210 is beneficial. Unlike conventional ammonia production processes which typically require large, expensive equipment to convert carbon-containing compounds into hydrogen for the production of ammonia, the small scale of the hydrogen production process 210 reduces the overall space required for hydrogen generation in the process. In addition, the cost of the equipment required to produce hydrogen may be reduced. Raw material costs may also be reduced because hydrogen may be produced from a renewable resource, water, rather than from expensive resources such as natural gas or other petroleum products. However, the hydrogen may also be produced from natural gas, petroleum, or other sources.

The reduced size of the equipment employed in hydrogen production process 210 as compared to the hydrogen production processes of conventional ammonia production plants is also beneficial because it allows the processes of various embodiments of the invention to be operated on-location, or near a location where the ammonia may be used. For instance, various embodiments of the invention enable apparatus for small scale ammonia production processes to be built and operated on-site, such as in the vicinity of a coal-fired power process. An ammonia production process installation according to embodiments of the invention may be built and operated as part of a plant for a coal-fired power process to provide ammonia for the coal-fired power process to reduce NOₓ pollutants produced by the coal-fired power process. Ammonia produced by an ammonia production process according to embodiments of the invention may be fed directly from the ammonia production process to the coal-fired power process without the need for storage or transportation. The integration of apparatus for an ammonia production process with the coal-fired power process plant according to embodiments of the invention may improve the economics of a process because a readily available ammonia supply may be integrated with the coal-fired power process without the associated costs of storage and transportation.

The reduced size of the processes of embodiments of the invention, combined with the ability of the processes to be powered by renewable resources, is also beneficial. For example, in many remote locations there is little or no power supply which can be used to operate a conventional ammonia production process. In addition, the raw materials, such as carbon-containing compounds, may not be readily available for producing hydrogen in a conventional process. It may also be economically infeasible to import such materials to an area where ammonia production is desired, such as in remote agricultural areas. The ammonia production processes of various embodiments of the invention, however, may be operated using renewable resources such as wind power, solar power, geothermal power, or hydroelectric power. In addition, the materials used to produce ammonia in some embodiments of the invention—air and water—may be more readily available than carbon-containing petroleum products conventionally required to produce the necessary hydrogen for ammonia production. Thus, an ammonia production process according to embodiments of the invention may be operated in a remote location using water, air, and other renewable energy sources to produce ammonia. This may be especially beneficial in those instances where supplies of water are available for agricultural purposes and where ammonia production or shipment and storage were not previously feasible.

The combustion processes 220 according to embodiments of the invention may also be configured to generate electricity or heat, which may be used in other processes or with the hydrogen production process 210. The additional electricity or heat produced by the combustion processes 220 may offset energy costs associated with the ammonia production process, may be used with other energy sources to provide energy to the ammonia production process, or may be used as energy for other processes.

Various embodiments of the invention may also be beneficial because the processes of embodiments of the invention may reduce the amount of pollutants generated in the overall ammonia production process. For instance, conventional ammonia production processes produce pollutants during the conversion of carbon-containing compounds into hydrogen. The energy used to convert such compounds into hydrogen also produces pollutants. The use of the hydrogen production processes 210 according to embodiments of the invention may reduce the overall amount of pollution per unit of ammonia produced because the splitting of water into hydrogen and oxygen does not produce any pollutants. In addition, the water splitting process may be operated using renewable power sources, such as solar power, wind power, geothermal power, and hydroelectric power, each of which do not produce pollutants. Further, various embodiments of the invention may be operated utilizing heat or electricity or a mixture thereof from a nuclear power process to split water or otherwise generate hydrogen for the ammonia production process.

Particular embodiments of the invention also decrease the amount of equipment required to produce nitrogen to be used in the ammonia production process. The supply of hydrogen as a slipstream of hydrogen to the combustion process 220 facilitates the complete combustion of the air fed to the combustion process 220. The complete combustion of oxygen in the air produces a product of water and nitrogen. Thus, relatively pure nitrogen may be produced using certain embodiments of the invention, which nitrogen may be fed directly to the ammonia production process following drying.

Various embodiments of the invention simplify the ammonia production process from non-carbon-containing compounds. The simplified ammonia production process is transportable, smaller, and more efficient than conventional ammonia production processes.

Having thus described certain embodiments of the present invention, it is understood that the invention defined by the appended claims is not to be limited by particular details set forth in the above description, as many apparent variations thereof are contemplated without departing from the spirit or scope thereof as hereinafter claimed.

What is claimed is:

1. A method for producing ammonia, comprising:
combining at least a first portion of a hydrogen stream with air;
combusting the at least a first portion of the hydrogen stream and the air to produce nitrogen; and
combining the nitrogen with at least a second portion of the hydrogen stream to produce ammonia.

2. The method of claim 1, wherein combining at least a first portion of a hydrogen stream with air comprises feeding the air and the at least a first portion of the hydrogen stream to a combustion process.

3. The method of claim 1, wherein combining at least a first portion of a hydrogen stream with air comprises feeding the at least a first portion of the hydrogen stream and air to a combustion process selected from the group consisting of a turbogenerator, a heat exchanger, and combinations thereof.

4. The method of claim 1, wherein combusting the at least a first portion of the hydrogen stream and the air to produce nitrogen comprises combusting the at least a first portion of the hydrogen stream and the air in a combustion process configured to generate electricity from the combustion.

5. The method of claim 4, wherein combusting the at least a first portion of the hydrogen stream and the air to produce nitrogen in a combustion process configured to generate electricity comprises combusting the at least a first portion of the hydrogen stream and the air in a combustion turbine.

6. The method of claim 1, wherein combusting the at least a first portion of the hydrogen stream and the air to produce nitrogen comprises combusting the at least a first portion of the hydrogen stream and the air in a combustion process configured to recover heat from the combustion.

7. The method of claim 1, wherein combusting the at least a first portion of the hydrogen stream and the air to produce nitrogen comprises combusting the at least a first portion of the hydrogen stream and the air to produce nitrogen and water vapor.

8. The method of claim 7, further comprising drying the nitrogen to remove the water vapor.

9. The method of claim 1, wherein combining the nitrogen with at least a second portion of the hydrogen stream to produce ammonia comprises:
mixing the nitrogen and the at least a second portion of the hydrogen stream;
feeding the nitrogen and hydrogen mixture to a methanator;
compressing the nitrogen and hydrogen mixture from the methanator; and
generating ammonia from the compressed nitrogen and hydrogen mixture.

10. The method of claim 9, wherein mixing the nitrogen and the at least a second portion of the hydrogen stream comprises mixing the nitrogen and the at least second portion of the hydrogen stream in a ratio of one part nitrogen to three parts hydrogen.

11. The method of claim 1, further comprising removing at least a portion of oxygen and carbon dioxide from the air before combining the at least a first portion of the hydrogen stream with the air.

12. The method of claim 11, wherein removing at least a portion of the oxygen and carbon dioxide from the air before combining the at least a first portion of the hydrogen stream with the air comprises passing the air through a pressure swing absorber or through a membrane.

13. A method for producing nitrogen, comprising:
combining a hydrogen stream and air; and
producing a moist nitrogen product comprising nitrogen by combusting the hydrogen stream and air.

14. The method of claim 13, wherein producing a moist nitrogen product by combusting the hydrogen stream and air comprises producing nitrogen and water vapor by combusting the hydrogen stream and air.

15. The method of claim 13, wherein producing a moist nitrogen product by combusting the hydrogen stream and air comprises producing nitrogen by combusting the air in an excess amount of hydrogen.

16. The method of claim 13, further comprising drying the nitrogen to remove water vapor.

17. The method of claim 13, further comprising removing at least a portion of oxygen and carbon dioxide from the air before combining the hydrogen stream and air.

18. The method of claim 13, further comprising producing ammonia from the nitrogen by combining the produced nitrogen with hydrogen.

19. An apparatus for producing ammonia, comprising:
at least one electrolytic cell configured to convert water into hydrogen and oxygen;
at least one renewable energy power source coupled to the at least one electrolytic cell to supply an electrical current to the at least one electrolytic cell;
at least one combustion apparatus configured to combust hydrogen produced by the at least one electrolytic cell with air to produce nitrogen; and
at least one ammonia generator configured to produce ammonia from nitrogen produced by the at least one combustion apparatus and hydrogen.

20. The apparatus of claim 19, further comprising at least one nitrogen drying apparatus coupled to the at least one combustion apparatus and configured to remove water vapor from the nitrogen produced by the at least one combustion apparatus.

21. The apparatus of claim 19, wherein the at least one ammonia generator configured to produce ammonia from nitrogen produced by the at least one combustion apparatus and hydrogen comprises at least one ammonia generator configured to produce ammonia from nitrogen produced by the at least one combustion apparatus and hydrogen produced by the at least one electrolytic cell.

22. The apparatus of claim 19, further comprising an air separation apparatus configured to separate the nitrogen from the air.
